(19) United States
(12) Patent Application Publication
(10) Pub. No.: US 2011/0084630 A1
(43) Pub. Date: Apr. 14, 2011

(54) SEWABLE LIGHT GUIDE DEVICE

(76) Inventor: Sen-Mei CHENG, Ho Mei Town (TW)

(21) Appl. No.: 12/830,507

(22) Filed: Jul. 6, 2010

(30) Foreign Application Priority Data
Oct. 9, 2009 (TW) 098218708

(51) Int. Cl. H05B 37/02; F21V 7/22

(52) U.S. Cl. 315/313; 362/611; 362/612

(57) ABSTRACT

A sewable light guide device includes a light source controlled to be on or off by a controller, and the light source includes a joint, and the joint is connected to a sewable light guide strip, and the light guide strip contains at least one light guide etch mark formed inside the light guide strip, and a joint element is installed at a side of the light guide strip along an axial direction, such that the joint element can be sewed or fixed to an object such as a bag, a shoe or a cloth, and the light guide strip is exposed from a surface of the object, and the light source can be turned on to drive the light guide strip to produce a light along the light guide etch mark, so as to improve the visually noticeability of the object.

### BACKGROUND OF THE INVENTION

1. Field of the Invention

The present invention relates to a technical area of light guide strips sewable or fixable to daily necessities such as bags, shoes, and clothes, and more particularly to a sewable light guide device with various changing effects and excellent applications.

2. Description of the Related Art

In general, objects such as bags, shoes and clothes are made of materials without a visually noticeable light emitting effect, and usually do not provide a warning effect while wearers are walking at nighttime or in a dark place. For example, an elderly person walking at night or early in the morning may not be noticed by drivers easily, and it may jeopardize the safety of the elderly person, and the aforementioned objects fail to provide warning or visually noticeable effects and convenient safety applications for those who hold a warning lamp or device such as a flash light.

### SUMMARY OF THE INVENTION

In view of the foregoing drawback of the conventional objects having a poor visually noticeable effect and an inconvenient application, the inventor of the present invention designed a sewable light guide device for objects in accordance with the present invention to overcome the drawback of the conventional objects.

It is a primary objective of the present invention to provide different ways of using a sewable light guide device as needed and a convenient application to achieve an excellent visually noticeable effect.

To achieve the aforementioned objective, the present invention provides a sewable light guide device, comprising a sewable transparent light guide strip, at least one light guide etch mark formed in the light guide strip, at least one joint element installed at a side of the light guide strip axially, and a light emitting source disposed opposite to an end of the light guide strip.

### BRIEF DESCRIPTION OF THE DRAWINGS

FIG. 1 is an exploded view of a sewable light guide device of the present invention;

FIG. 2 is a perspective view of a sewable light guide device of the present invention before a light guide strip is combined with a light emitting source;

FIG. 3 is a perspective view of a sewable light guide device of FIG. 2 after the light guide strip is combined with the light emitting source;

FIG. 4 is a perspective view of a light guide strip and a joint element in accordance with a preferred embodiment of the present invention;

FIG. 5 is a perspective view of a light guide strip and a joint element in accordance with a preferred embodiment of the present invention;

FIG. 6 is a perspective view of a light guide strip and a joint element in accordance with a preferred embodiment of the present invention;

FIG. 7 is an exploded view of a sheath and a light emitting source in accordance with a preferred embodiment of the present invention;

FIG. 8 is a schematic view of connecting a sheath and a light emitting source in accordance with a preferred embodiment of the present invention;

FIG. 9 is an exploded view of a sheath and a light emitting source in accordance with a preferred embodiment of the present invention;

FIG. 10 is an exploded view of a sheath and a light emitting source in accordance with a preferred embodiment of the present invention;

FIG. 11 is a perspective view of a sheath and a light emitting source in accordance with a preferred embodiment of the present invention;

FIG. 12 is a perspective view of a light guide strip in accordance with a preferred embodiment of the present invention; and

FIG. 13 is a perspective view of a light guide strip in accordance with a preferred embodiment of the present invention.

### DETAILED DESCRIPTION OF THE PREFERRED EMBODIMENTS

The structural assembly, technical characteristic and effects of the present invention will become apparent with the detailed description of preferred embodiments and the illustration of related drawings.

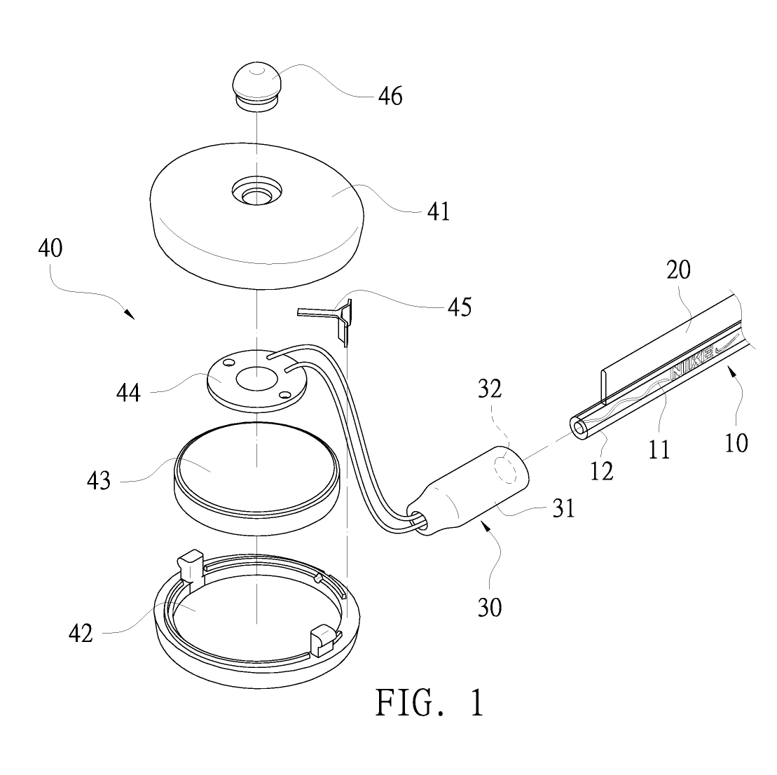

With reference to FIGS. 1 to 3 for a sewable light guide device of the present invention, the sewable light guide device comprises:

a sewable transparent light guide strip 10, made of a soft material, and substantially in a circular tubular shape, wherein the light guide strip 10 contains at least one light guide etch mark 11 in a form of a spiral line, a line, a text, a symbol or a figure, and the light guide strip 10 can be in any desired color, and a coupling portion 12 is formed at an end of the light guide strip 10;

at least one joint element 20, fixed to a lateral of the light guide strip 10 axially, and disposed at a position other than the coupling portion 12, wherein the joint element 20 and the light guide strip 10 are made of the same material and formed integrally by an injection molding or made of different materials, and the joint element 20 is substantially in a non-translucent color, preferably a dark color, and most preferably black, for preventing a possible reduced intensity of the light passing through needle holes produced after the sewing process, and the joint element is sewed or fixed onto an internal side of a desired object such as a bag, a shoe or a cloth, and the light guide strip 10 in a long strip shape can be exposed from an external side of the object to form the sewed edge of the object;

a light emitting source 30, including a joint 31, at least one LED (not shown in the figure) installed in the joint 31, and a containing hole 32 formed at a position opposite to the LED and provided for containing the coupling portion 12 of the light guide strip 10; and

a controller 40, electrically coupled to the light emitting source 30, and including an upper casing 41 and a lower casing 42 engaged with each other, wherein the upper casing 41 and the lower casing 42 contains a battery 43 electrically coupled to a printed circuit board (PCB) 44 and a conductive plate 45, and a press button 46 penetrated through the upper casing 41, and provided for controlling an electric power source of the printed circuit board 44, and the printed circuit board 44 includes two electric wires 47 coupled to the joint 31 of the light emitting source 30, thereby the aforementioned elements constitute the sewable light guide device of the present invention.

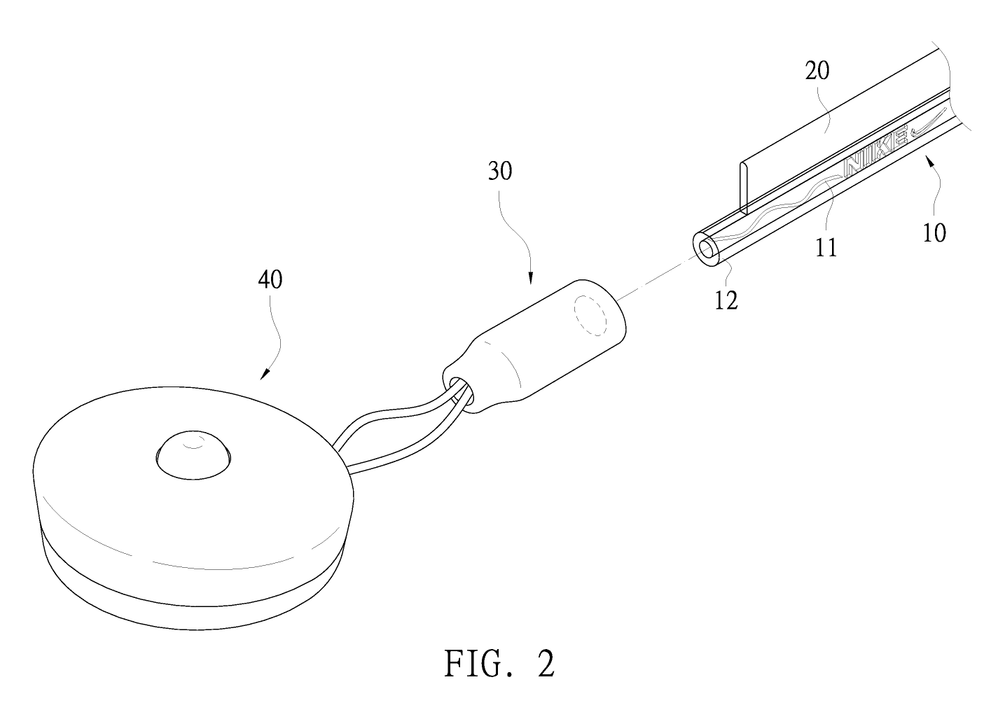

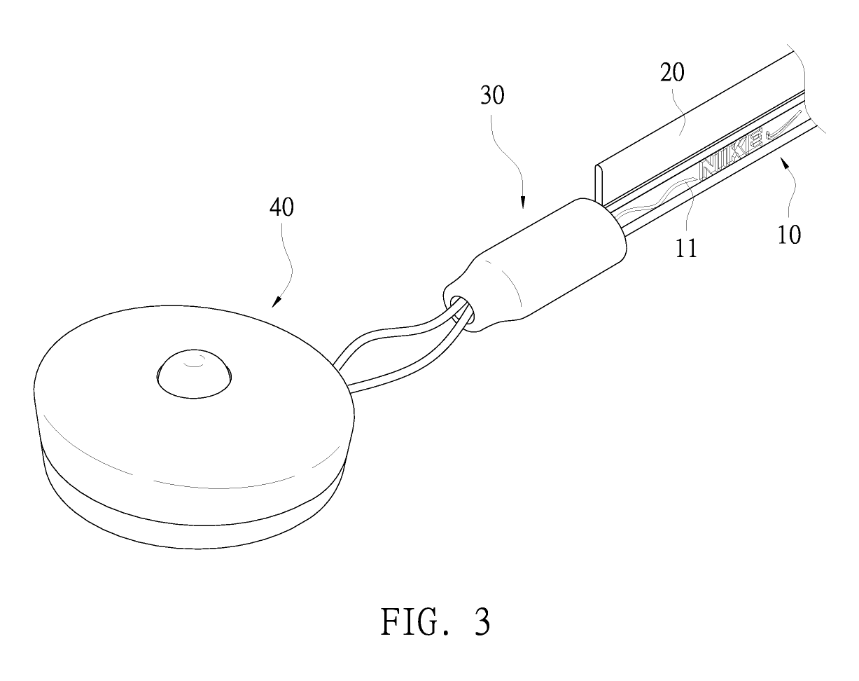

When use (as shown in FIGS. 2 and 3), the joint element 20 is sewed or fixed onto a surface of an object (not shown in the figures) such as a bag, cloth or shoe, and provided for sewing the light guide strip 10 with a sewing edge or a strip line onto a surface of the object. During use, the coupling portion 12 of the light guide strip 10 is sheathed into the joint 31, and the press button 46 is pressed to turn on the LED in the joint 31 to emit light, such that the light of the LED can be guided along the spiral light guide etch mark 11 of the light guide strip 10 to emit light, so as to achieve the visually noticeable effect and a convenient application. If a cleanup is required, the coupling portion 12 of the light guide strip 10 can be detached from the joint 31 easily, and the controller 40 together with the light emitting source 30 can be removed to facilitate the cleanup of the object, so as to improve the convenience and safety.

In addition, the shape of the light guide strip, the light guide etch mark formed in the joint element and the shape of the light guide etch mark in the joint element can be changed according to the user's requirements.

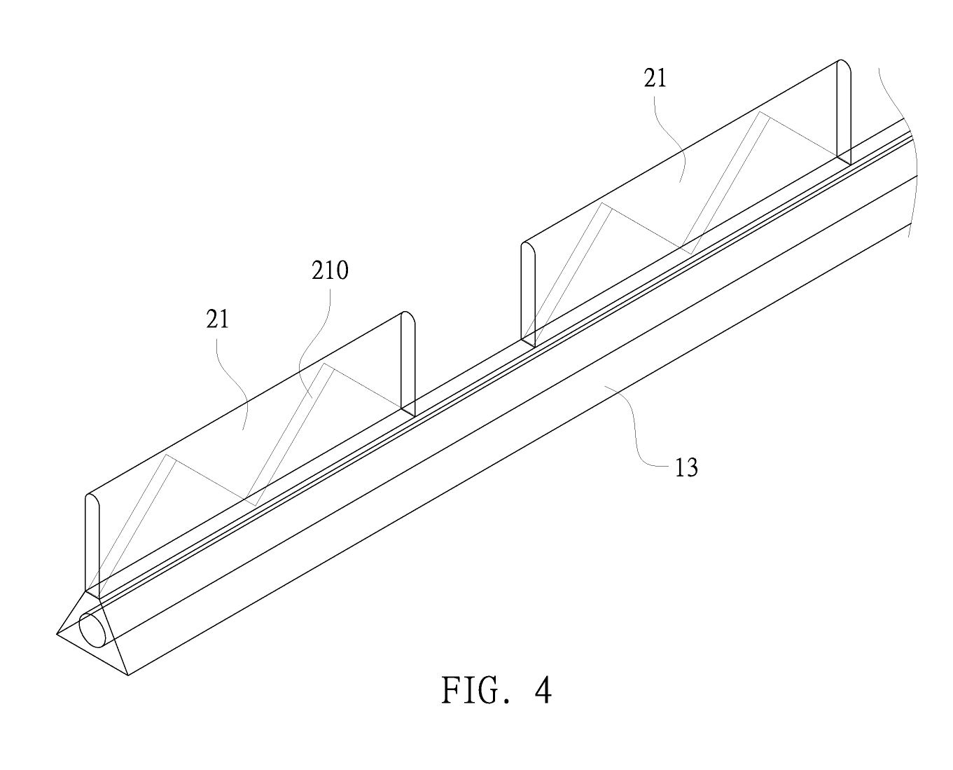

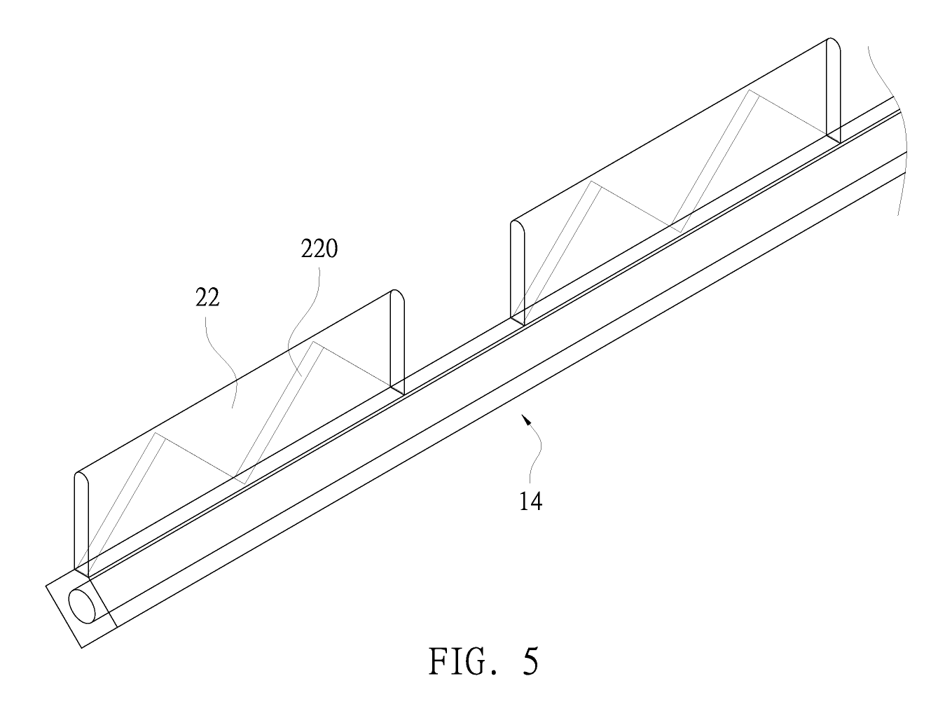

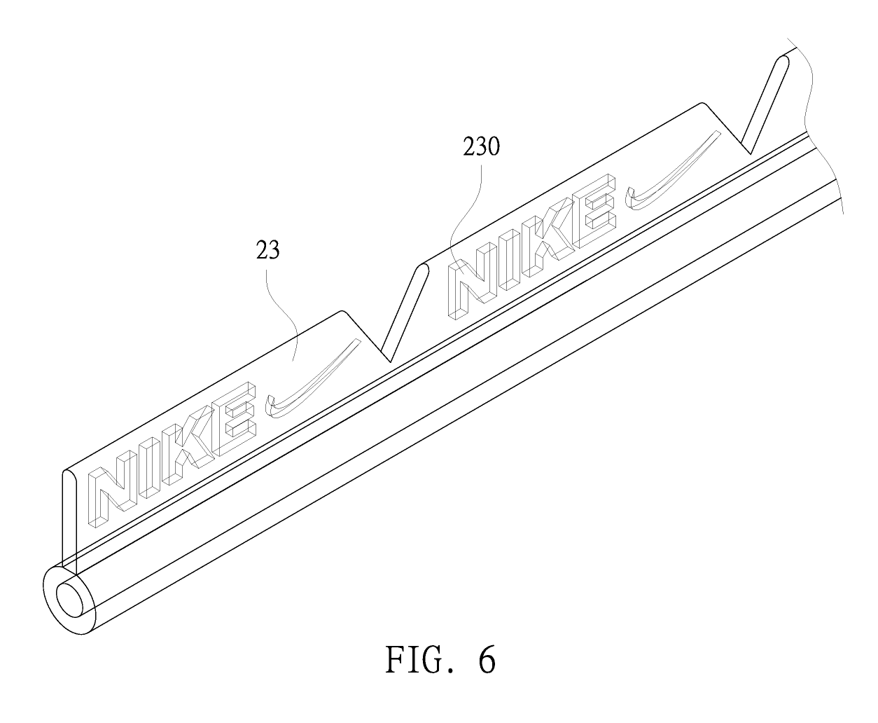

With reference to FIGS. 4 and 5 for a preferred embodiment of the present invention, the light guide strip 13, 14 has a radial cross-section substantially a trapezium shaped strip (as shown in FIG. 4) or a rectangular shaped strip (as shown in FIG. 5), and the joint elements 21, 22 can be made of a translucent material, and the joint elements 21, 22 can be in a continuous or non-continuous form. In FIGS. 4 and 5, the joint elements 21, 22 are in a non-continuous form, and light guide etch marks 210, 220 with a desired pattern can be formed in the joint element 21, 22, and the light guide etch marks 210, 220 are in a continuous triangular shape as shown in the figures. In a preferred embodiment of the present invention as shown in FIG. 6, the joint element 23 may have a light guide etch mark 230 in a form of a trademark to cope with a user's design.

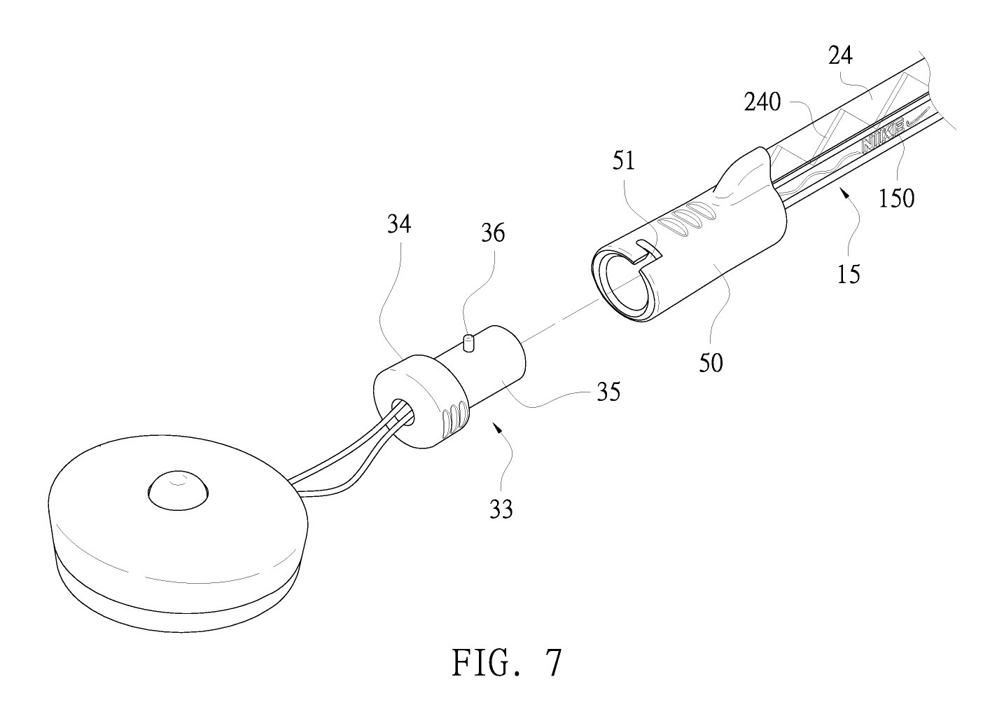

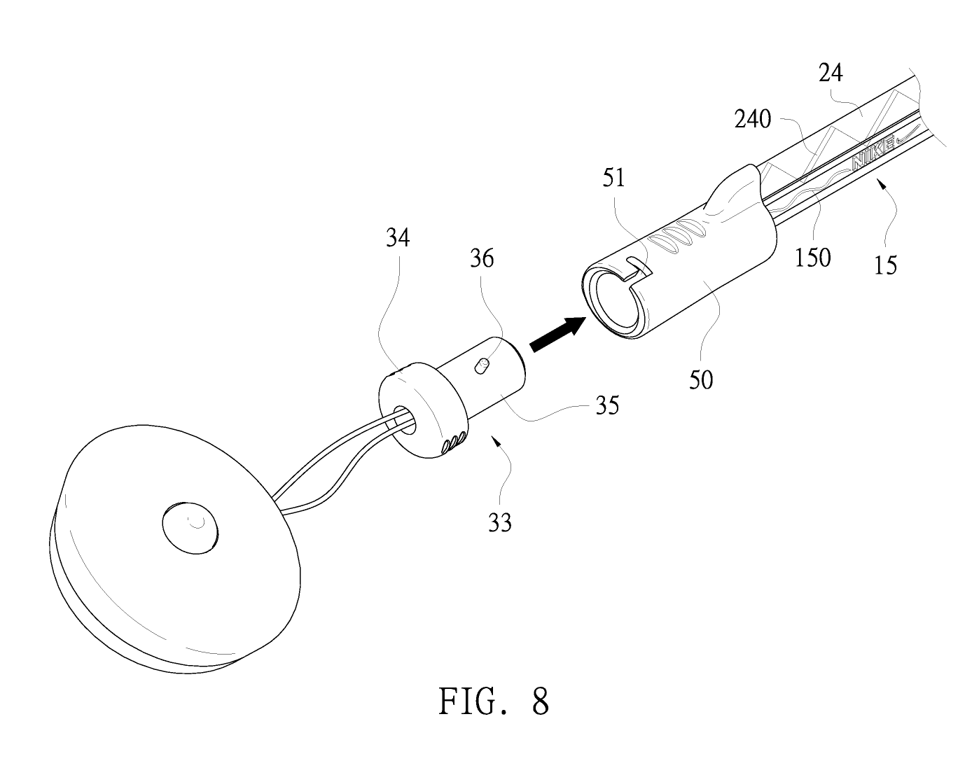

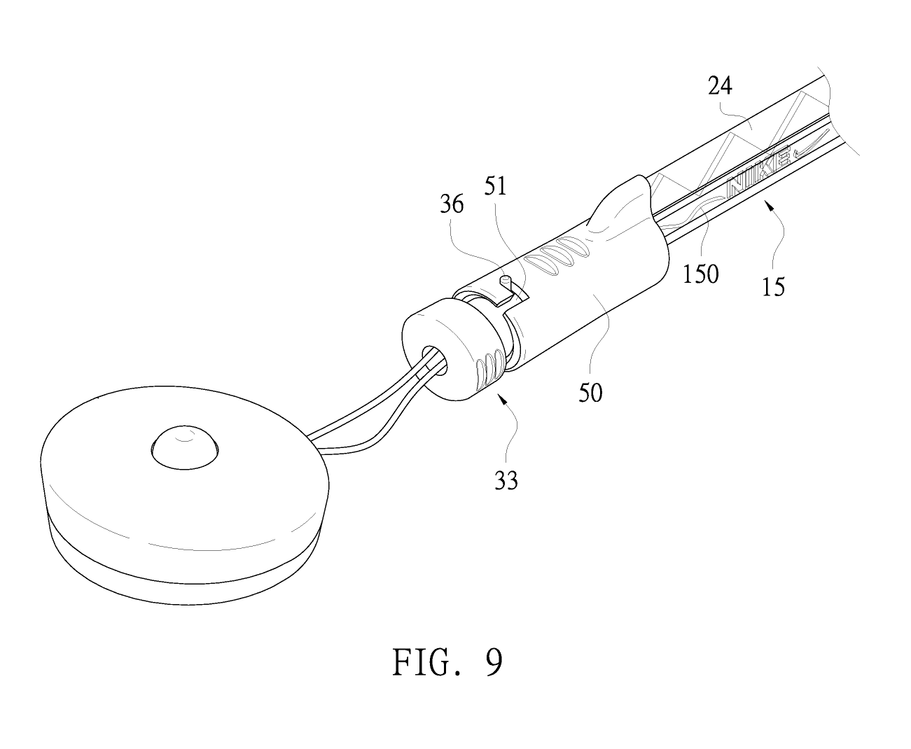

With reference to FIGS. 7 to 9, ends of the light guide strip 15 and the joint element 24 include a hollow sheath 50, and the sheath 50 has an inverted L-shaped guide slot 51 formed at an end other than the light guide strip 15, and the joint 34 of the light emitting source 33 includes an embedding portion 35 formed at a position opposite to the sheath 50, and the embedding portion 35 includes a positioning pillar 36 disposed at a periphery of the embedding portion 35. The embedding portion 35 is sheathed into the sheath 50, and the positioning pillar 36 is moved along the inverted L-shaped guide slot 51, such that the embedding portion 35 of the light emitting source 33 can be embedded into the sheath 50. When the light produced by the LED (not shown in the figures) of the light emitting source 33 is projected at the light guide strip 15 and the joint element 24 to emit light, the light source can be emitted along the light guide etch marks 150, 240 of the light guide strip 15 and the joint element 24 respectively.

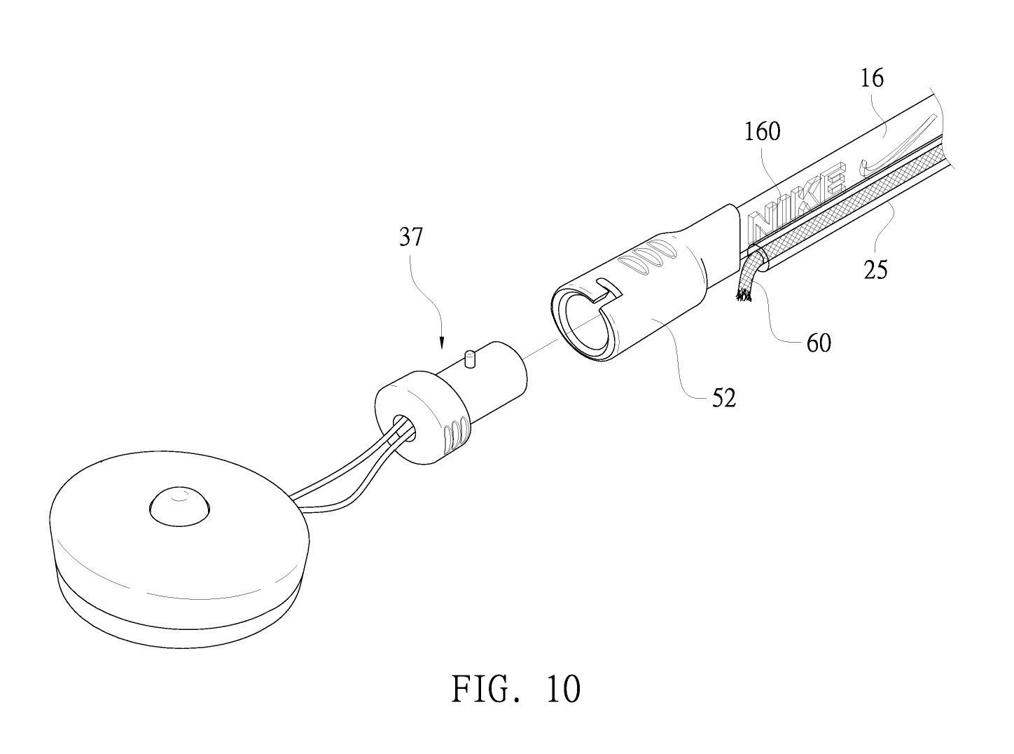

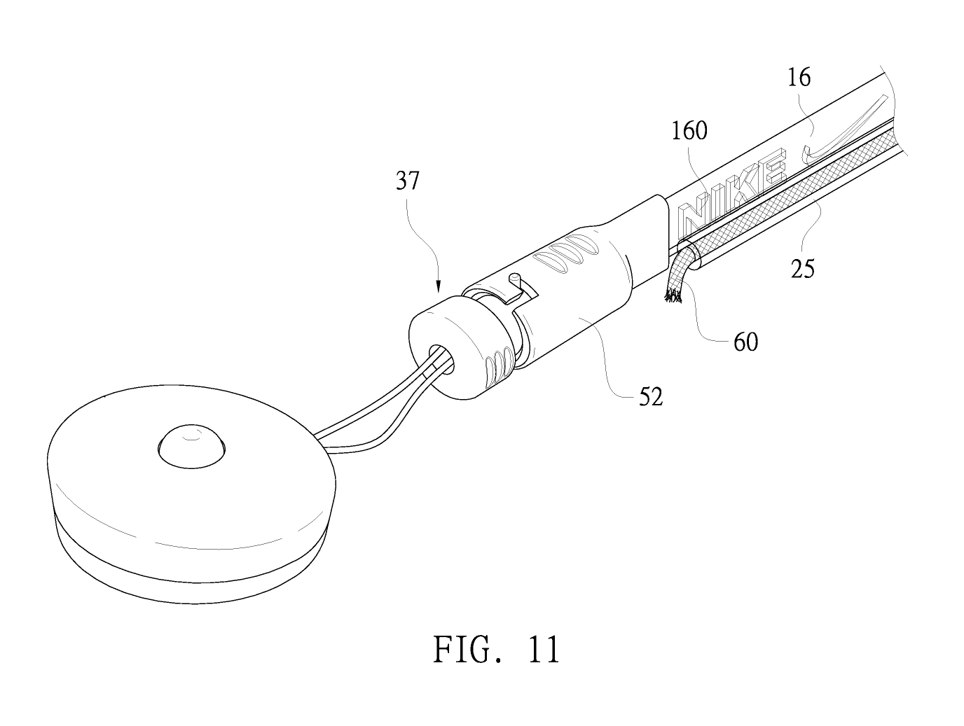

With reference to FIGS. 10 and 11 for a preferred embodiment of the present invention, the coupling element 25 is substantially in a circular tubular shape, and the light guide strip 16 is substantially in a plate shape, and the light guide strip 16 includes at least one light guide etch mark 160 in a form of a figure or a text as required, or a trademark or any other patter as shown in the figures, and a sheath 52 is disposed at an end of the light guide strip 16 and provided for embedding the light emitting source 37. During use, a string 60 is passed into the coupling element 25 to fix the desired object.

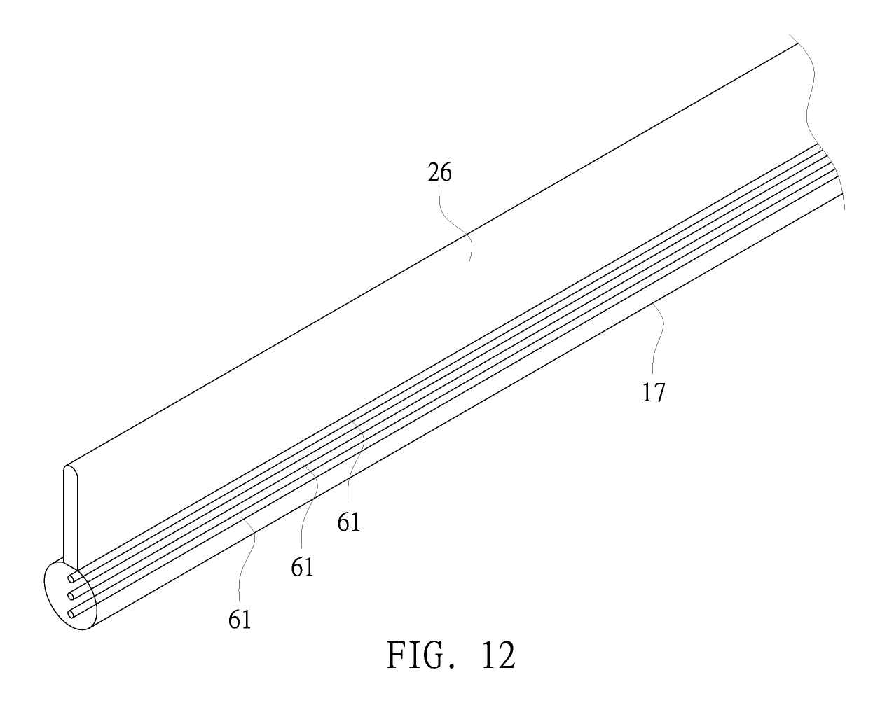

With reference to FIG. 12 for a light guide strip in accordance with a preferred embodiment of the present invention, the transparent solid body of the light guide strip 17 contains at least one color translucent strip 61, and the light guide strip 17 includes a joint element 26 installed at a lateral of the light guide strip 17 axially, and the joint element 26 is substantially in a non-translucent color, preferably a dark color, and most preferably black for preventing a possible reduced intensity of the light passing through needle holes produced after the sewing process, such that if the light emitting source is projected at an end of the light guide strip, the color strips will produce a light guide effect to emit color lights, and the light guide strip can be connected to the light emitting source and the controller.

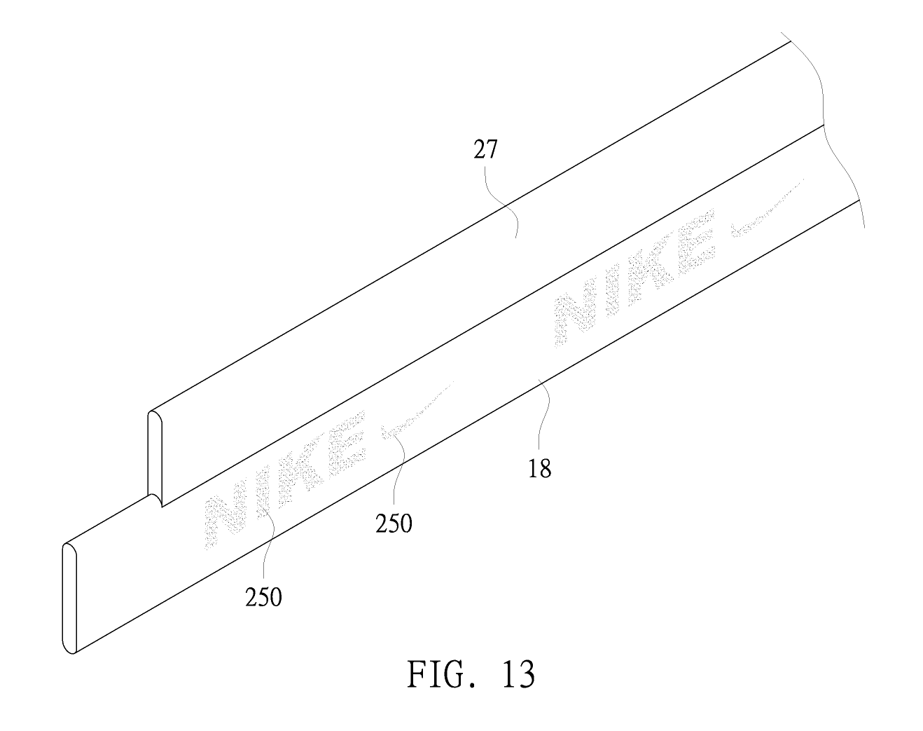

With reference to FIG. 13 for a light guide strip in accordance with a preferred embodiment of the present invention, the light guide strip 18 is substantially a flat solid body having a light guide etch mark 250 in a form of a laser trademark, a text, a symbol or a figure formed by a plurality of dots and lines on a surface of the light guide strip 18, and the light guide strip 18 includes a joint element 27 installed at a lateral of the light guide strip 18 axially, and the joint element 27 is substantially in a non-translucent color, preferably a dark color, and most preferably black, for preventing a possible reduced intensity of the light passing through needle holes produced after the sewing process, such that if the light emitting source is projected at an end of the light guide strip, the light guide etch mark on the surface of the light guide strip will produce a light guide effect to emit light, and the light guide strip can be connected to the light emitting source and the controller.

While the invention has been described by means of specific embodiments, numerous modifications and variations such as a change of numeric values or a replacement of an equivalent component could be made thereto by those skilled in the art without departing from the scope and spirit of the invention set forth in the claims.

In summation of the above description, the present invention improves the performance over the conventional structure and further complies with the patent application requirements and thus is duly submitted for patent application.

What is claimed is:

1. A sewable light guide device, comprising:
a sewable transparent light guide strip, having at least one light guide etch mark installed therein;
at least one joint element, fixed to a lateral of the light guide strip axially; and
a light emitting source, disposed opposite to an end of the light guide strip.

2. The sewable light guide device of claim 1, wherein the light guide strip is in a circular tubular shape, a trapezium shape, or a rectangular shape.

3. The sewable light guide device of claim 1, wherein the light guide strip includes a light guide etch mark in a form of a line, a text, a symbol or a figure.

4. The sewable light guide device of claim 1, wherein the light guide strip is substantially in a plate shape.

5. The sewable light guide device of claim 1, wherein the light guide strip includes a coupling portion formed at an end of the light guide strip, and the light emitting source includes a joint, and the joint includes at least one LED installed at an internal side of the joint, and a containing hole formed at a position opposite to the LED, and the coupling portion of the light guide strip is contained in the containing hole.

6. The sewable light guide device of claim 1, wherein the joint element and the light guide strip are made of the same material or different materials and formed integrally by injection molding.

7. The sewable light guide device of claim 1, wherein the joint element is substantially in a non-translucent color.

8. The sewable light guide device of claim 1, wherein the joint element is substantially transparent, and the joint element includes a light guide etch mark selected from the collection of a line, a text, a symbol and a figure, and ends of the joint element and the light guide strip are disposed opposite to the light emitting source.

9. The sewable light guide device of claim 1, wherein the light emitting source includes at least one LED.

10. The sewable light guide device of claim 1, wherein the light emitting source is connected to a controller, and the controller is provided for controlling the light emitting source to be turned on or off.

11. The sewable light guide device of claim 1, wherein the light emitting source is connected to a controller, the controller is provided for controlling the light emitting source to be turned on or off, the controller includes an upper casing and a lower casing engaged with each other, and the upper casing and the lower casing contain a battery electrically coupled to a printed circuit board (PCB) and a conductive plate, and a press button penetrated through the upper casing and provided for controlling the electric power source of the printed circuit board, and the printed circuit board includes two electric wires connected to the light emitting source.

12. The sewable light guide device of claim 1, wherein the joint element is in a continuous or non-continuous form.

13. The sewable light guide device of claim 1, wherein the light guide strip and the joint element include a hollow sheath formed at an end, and the sheath includes an inverted L-shaped guide slot formed at an end other than the end with the light guide strip, and the joint of the light emitting source includes an embedding portion formed at a position opposite to the sheath, and the embedding portion includes a positioning pillar formed at a periphery of the embedding portion, and the embedding portion is sheathed into the sheath, and the positioning pillar is positioned at the inverted L-shaped guide slot.

14. The sewable light guide device of claim 1, wherein the coupling element is in a circular tubular shape.

15. The sewable light guide device of claim 1, wherein the light guide strip is substantially a flat solid body, with a surface having a light guide etch mark in a form of a laser trademark, a text, a symbol, or a figure consisting a plurality of dots or lines, and the light guide strip has a flat joint element installed on a lateral of the light guide strip axially, and the joint element is substantially in a non-translucent color.

16. A sewable light guide device, comprising:
a sewable transparent light guide strip, contains at least one color translucent strip in a transparent solid body of the light guide strip;
at least one joint element, fixed to a lateral of the light guide strip axially;
a light emitting source, installed at an end opposite to the light guide strip.

17. The sewable light guide device of claim 16, wherein the joint element is substantially in a non-translucent color.

18. The sewable light guide device of claim 16, wherein the light emitting source includes at least one LED.

19. The sewable light guide device of claim 16, wherein the light emitting source is connected to a controller, and the controller is provided for controlling the light emitting source to be turned on or off.

20. The sewable light guide device of claim 16, wherein the light emitting source is connected to a controller, the controller is provided for controlling the light emitting source to be turned on or off, the controller includes an upper casing and a lower casing engaged with each other, and the upper casing and the lower casing contain a battery electrically coupled to a printed circuit board (PCB) and a conductive plate, and a press button penetrated through the upper casing for controlling an electric power source of the printed circuit board, and the printed circuit board includes two electric wires connected to the light emitting source.
